(19) United States
(12) Patent Application Publication
(10) Pub. No.: US 2015/0090755 A1
(43) Pub. Date: Apr. 2, 2015

(54) Friction Supported Automobile Dashboard Hanging Receptacle

(71) Applicant: Joanne G. Register, Jacksonville, FL (US)

(72) Inventor: Joanne G. Register, Jacksonville, FL (US)

(21) Appl. No.: 14/501,866

(22) Filed: Sep. 30, 2014

Related U.S. Application Data
(60) Provisional application No. 61/884,368, filed on Sep. 30, 2013.

(51) Int. Cl. B60R 7/04

(52) U.S. Cl. CPC B60R 7/04
USPC 224/563

(57) ABSTRACT

A hanging or suspended receptacle for an automobile interior, the receptacle being in the form of a bag or pouch joined to an elongated hanging strap member, with the receptacle being retained in a suspended position by a weighted anchor member that rests on the upper surface of the automobile dashboard or other substantially horizontal surface. A high-friction, non-slip layer or backing member is provided on the rear of the weighted anchor, and also preferably on at least a portion of the rear of the strap member.

This application claims the benefit of U.S. Provisional Patent Application Ser. No. 61/884,368, filed Sep. 30, 2013.

### BACKGROUND OF THE INVENTION

This invention relates generally to the field of receptacles, such as bags or pouches, and more particularly to receptacles utilized in automobiles to hold objects, printed material, trash or the like, and even more particularly to such receptacles that are suspended from a structural part of the automobile within the interior.

While automobiles (the term herein used for the purpose of encompassing cars, trucks, vans, RV's and motor vehicles in general) are provided with built-in receptacles for holding objects, such as glove boxes and door pockets, it is often desirable to have additional receptacles. To this end, it is known to provide hanging receptacles that are attached, secured or otherwise mounted to structural members within the automobile interior, such as for example by providing hooks, loops or edges that fit into openings in the air vents or window openings or over control knobs or handles, or by providing attachment members that are bonded or otherwise permanently affixed to the car interior. Examples of such devices are shown in U.S. Pat. No. 1,486,566 to Crecelius, U.S. Pat. No. 2,920,670 to Mohlmann, U.S. Pat. No. 3,133,690 to Lui, U.S. Pat. No. 3,598,297 to Welch, U.S. Pat. No. 4,154,383 to Honatzis, U.S. Pat. No. 5,031,808 to Dolenc, U.S. Pat. No. 5,246,190 to Swirkal, U.S. Pat. No. 6,626,337 to Cox, and U.S. Pat. No. D321,772 to Johnson.

These known devices suffer from differing drawbacks. Bonding or direct mechanical attachment to the interior of the automobile is not desirable because of the possible damage to the interior. Specialized hanging elements such as hooks or rods may only be suitable for certain automobiles or for certain interior configurations and designs, and are bulky and obtrusive. Receptacles suspended from knobs or vents may cause damage if the receptacles are too heavily loaded.

It is an object of this invention to provide a hanging or suspended receptacle that does not suffer from the drawbacks and problems inherent in known devices, by providing a hanging receptacle that is not permanently affixed to the automobile, may be located in various locations, is easily removed from the automobile and will not cause damage if the receptacle is too heavily loaded.

### SUMMARY OF THE INVENTION

The invention is a hanging or suspended receptacle for an automobile interior, the receptacle comprising a bag or pouch joined to an elongated strap member, with the receptacle being retained in a suspended position by a weighted anchor member joined to the strap member that is adapted to rest on the upper surface of the automobile dashboard. A high-friction, non-slip layer or backing member is provided on the rear or bottom of the weighted anchor member, and also preferably on the rear of the strap member.

In an alternative wording, the invention comprises in various embodiments a hanging receptacle comprising a pouch, an elongated strap member attached to said pouch, a weighted anchor member attached to said elongated strap member, and a high-friction layer affixed to said weighted anchor member; further comprising a second high-friction layer affixed to said elongated strap member; wherein said high-friction layer is composed of a rubber or polymer material; and/or wherein said high-friction layer and aid second high-friction layer are composed of a rubber or polymer material. Further, a hanging receptacle wherein said second high-friction layer is affixed to only a portion of said elongated strap member; and/or said weighted anchor member having at least one substantially flat surface, and wherein said high-friction layer is affixed to said substantially flat surface.

### BRIEF DESCRIPTION OF THE DRAWINGS

FIG. 1 is a front view of an embodiment of the invention.

FIG. 2 is a side view of the embodiment of FIG. 1, showing the high-friction backing layers on both the weighted anchor member and the elongated strap member.

FIG. 3 is a rear view of a portion of the embodiment of FIG. 1, showing the high-friction backing layers on both the weighted anchor member and the elongated strap member.

### DETAILED DESCRIPTION OF THE INVENTION

With reference to the drawings, the invention will now be described in detail. In a general sense, the invention is a friction supported automobile dashboard hanging receptacle, the term receptacle used herein to include a bag or pouch capable of receiving and retaining objects such as maps, cell phones, sunglasses, snacks, trash, etc.

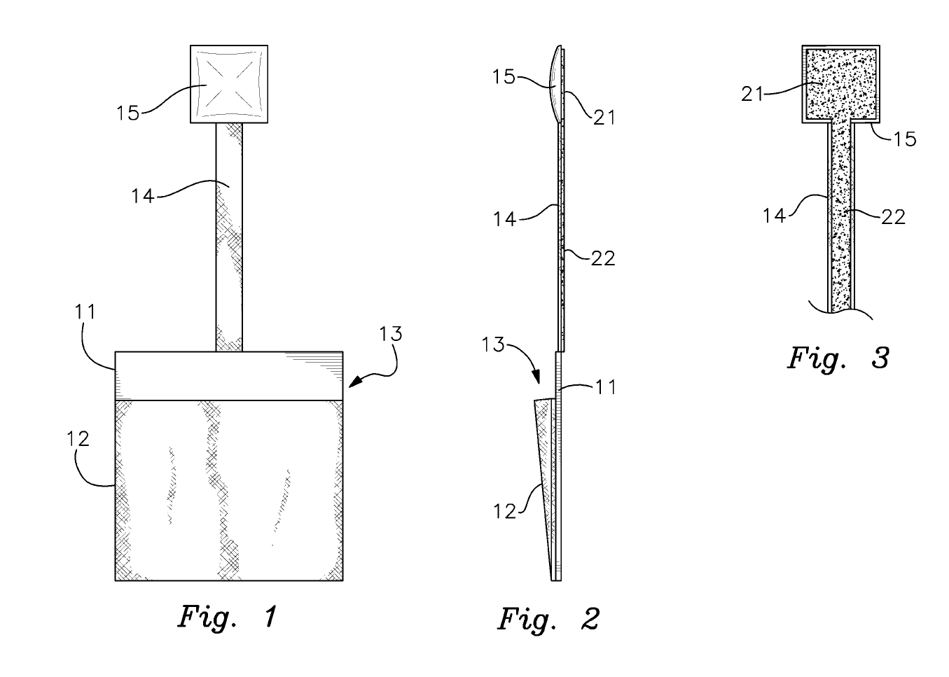

In the embodiment illustrated in FIGS. 1-3, the invention is shown to be a hanging or suspended pouch or pocket 13 for use in the interior of an automobile, the pouch 13 being formed and defined by the combination of a front member or panel 12 and a rear member or panel 11, which are connected in suitable manner, such as by stitching, gluing, heat bonding, etc., along their sides and bottom to form an open-topped structure. Alternatively, the front member 12 may be joined to the rear panel 11 by side panels (not shown). The pouch 13 is joined to a flexible, elongated hanging strap member 14 at the lower end of the strap member 14, again in suitable manner such as by stitching, adhesive, heat bonding, etc. The upper end of the strap member 14 is joined to a weighted anchor member 15, again in suitable manner such as by stitching, adhesive, heat bonding, etc. The anchor member 15 may be weighted with various filler materials, such as for example metal spheres or bars, ceramic members or powders, sand, etc. The weighted anchor member 15 comprises at least one substantially flat surface, which in use defines the rear or bottom of the weighted anchor member 15 which is placed onto the retaining surface.

A high-friction, non-slip layer or backing member 21 is provided on the substantially flat surface of the weighted anchor member 15. The backing layer 21 may be composed of a flexible sheet material of rubber or polymer possessing rubber-like non-skid properties, such as for example a neoprene material, and may be affixed to the rear of the anchor member 15 by any suitable means, such as stitching, adhesive, heat-bonding, etc. Alternatively, the backing layer 21 may be a coating applied to the rear of the anchor member 15.

Preferably a second high-friction, non-slip layer or backing member 22, such as for example a neoprene material, is also positioned on the rear of the strap member 14 by any suitable means, such as stitching, adhesive, heat-bonding, etc. Alternatively, the strap backing layer 22 may be a coating applied to the rear of the strap member 14. The strap backing layer 22 may extend the full length of the strap member 14, as shown in the drawings, or may only cover an upper portion of the strap member 14.

With this structure, the pouch 13 is retained in a suspended position by placing the weighted anchor member 15 on the upper surface of the automobile dashboard or any other substantially horizontal surface, the combination of the weight of the anchor member 15 and the high-friction anchor backing layer 21, and the second high-friction anchor backing layer 22 if present, making sufficient surface area contact with the top and front of the dashboard to maintain the pouch 13 in a suspended position even when the pouch 13 is loaded with weighty material. No damage or marring of the dashboard or other surface by the anchor weight 15 or of the dashboard face by the strap member 14 occurs, as there is no permanent affixation and the high-friction layers 21 and 22 present soft, non-abrasive surfaces. The device is easily removed or re-positioned as desired, and this construction allows the device to be universally suitable to all automobiles. In the event that the pouch 13 is overloaded, the anchor member 15 simply slips off the dashboard without causing damage.

While described herein as a device for use in an automobile interior, it is to be understood that the construction and design of the device would enable the device to be utilized in other situations, such as for example by suspending the pouch 13 from a table or desk.

It is understood that equivalents and substitutions for elements set forth above may be obvious to those of skill in the art, and therefore the true scope and definition of the invention is to be as set forth in the following claims.

I claim:

1. A hanging receptacle comprising a pouch, an elongated strap member attached to said pouch, a weighted anchor member attached to said elongated strap member, and a high-friction layer affixed to said weighted anchor member.

2. The hanging receptacle of claim 1, further comprising a second high-friction layer affixed to said elongated strap member.

3. The hanging receptacle of claim 1, wherein said high-friction layer is composed of a rubber or polymer material.

4. The hanging receptacle of claim 2, wherein said high-friction layer and aid second high-friction layer are composed of a rubber or polymer material.

5. The hanging receptacle of claim 1, wherein said pouch comprises a front panel joined to a back panel.

6. The hanging receptacle of claim 2, wherein said second high-friction layer is affixed to only a portion of said elongated strap member.

7. The hanging receptacle of claim 1, said weighted anchor member having at least one substantially flat surface, and wherein said high-friction layer is affixed to said substantially flat surface.

8. The hanging receptacle of claim 2, said weighted anchor member having at least one substantially flat surface, and wherein said high-friction layer is affixed to said substantially flat surface.
